(19) United States
(12) Patent Application Publication
(10) Pub. No.: US 2026/0167794 A1
(43) Pub. Date: Jun. 18, 2026

(54) EXTRUSION COMPOSITIONS COMPRISING RECYCLED POLYAMIDES RECOVERED UPON EXPLOITATION OF OFF-SHORE OR ON-SHORE OIL OR GAS DEPOSITS

(71) Applicant: ARKEMA FRANCE, Puteaux (FR)

(72) Inventors: Florence CHURLAUD, Serquigny (FR); Thomas PRENVEILLE, Serquigny (FR); Marjorie MARCOURT, Serquigny (FR); François FERNAGUT, Serquigny (FR)

(73) Assignee: ARKEMA FRANCE, Puteaux (FR)

(21) Appl. No.: 19/128,785

(22) PCT Filed: Nov. 10, 2023
(86) PCT No.: PCT/FR2023/051768

§ 371 Date: May 9, 2025

(30) Foreign Application Priority Data
Nov. 10, 2022 (FR) FR2211749

(51) Int. Cl. C08J 11/06; B29C 48/00; B29C 48/09; B29K 23/00; B29K 77/00; B29K 307/04; B29K 309/08; B29K 507/04; B29K 511/00; B29L 23/00; C08J 3/00; C08J 3/12

(52) U.S. Cl. CPC C08J 11/06; B29C 48/022; B29C 48/09; C08J 3/005; C08J 3/12; B29K 2023/00; B29K 2077/00; B29K 2307/04; B29K 2309/08; B29K 2507/04; B29K 2511/00; B29L 2023/22; C08J 2333/24; C08J 2433/24

(57) ABSTRACT

An extrusion composition comprising, by weight: a) 35 to 100% of at least one semi-crystalline aliphatic polyamide PA1 comprising at least 30% of recycled semi-crystalline aliphatic polyamide PA2 recovered from used or end-of-life pipes for exploiting off-shore or on-shore oil or gas deposits, said recycled semi-crystalline aliphatic polyamide PA2 having undergone a washing and/or compounding step upon removing and grinding the pipe to form granules; b) 0 to 65% of at least one reinforcing fiber; c) 0 to 40% of at least one impact modifier; d) 0 to 30% of a filler, e) 0 to 10% of at least one additive, the sum of components a+b+c+d+e being equal to 100%, the inherent viscosity of said composition, determined according to ISO 307: 2007 in m-cresol at 20° C., being greater than or equal to 1.2 dl/g.

The present invention relates to extrusion compositions comprising recycled polyamides derived from the exploitation of offshore or onshore oil or gas deposits.

### PRIOR ART

In the exploitation of offshore or onshore oil or gas deposits, flexible pipes are required to connect the various devices around the platform. These pipes must withstand oil which is hot, gas, water and mixtures of at least two of these products for periods of time which may be up to 20 years. These pipes generally consist of an inner, unsealed metal layer formed by a helically-wound, profiled metal strip such as a stapled foil, which gives the pipe its shape, and then a polymer is extruded onto this layer to provide the seal, and then other protective and reinforcing layers such as metal fiber webs and rubbers are finally added.

Long-chain polyamides have been used for many years in the exploitation of offshore and onshore oil and gas deposits.

However, it is necessary to clean these pipes by circulating therein methanol, for example, to remove hydrates. The drawback of methanol is that it penetrates deeply into the polyamide. Methanol is therefore lost, but plasticizer and/or modifiers may also be extracted from the polyamide by the methanol, leading to degraded mechanical properties and premature aging of the pipe.

Furthermore, several tens to hundreds of tonnes of long-chain polyamides derived from pipes used in the exploitation of offshore or onshore oil and gas deposits will have to be recycled in the coming years, due to the fact that they have reached the end of their useful life. However, these polyamides cannot be used after simple grinding due to the pollutants they contain, originating from the extracted oil or gas.

Polyamides (PA) derived from pipes used in the exploitation of offshore or onshore oil and gas deposits cannot be used as they are.

They must be ground so as to be able to be transformed into a part having a different shape for a different application.

After grinding, the polyamide to be recycled must also be washed and/or compounded in order to extract the vast majority of pollutants (with solvents, in the melt, under vacuum, etc.). However, the extraction is not necessarily complete.

Without this washing and/or compounding step, the manufactured parts exhibit exudation. This exudate may be toxic to the user, and may give rise to a greasy appearance on the parts.

Moreover, the polyamides to be recycled may be to a large part hydrolyzed and thus not extrudable. In this case, they must be exposed to a high vacuum (with addition of a catalyst if necessary) to increase their viscosity and make them extrudable.

It is thus necessary to be able to provide a composition which, firstly, can be extruded in complete safety for the manipulator (no release of toxic gases) and, secondly, to obtain all types of extruded parts that are stable over time (no exudation).

The present invention thus relates to an extrusion composition comprising, by weight:
a) from 35% to 100%, in particular from 35% to 96.9%, of at least one semicrystalline aliphatic polyamide PA1 comprising at least 30%, in particular at least 50%, of recycled semicrystalline aliphatic polyamide PA2 originating from used or end-of-life pipes which have been used in the exploitation of offshore or onshore oil or gas deposits, in particular offshore deposits, said recycled semicrystalline aliphatic polyamide PA2 having undergone a washing and/or compounding step after removal and grinding in the form of granules of said pipe;
b) from 0 to 65%, in particular from 0 to 10%, of at least one reinforcing fiber;
c) from 0 to 40%, in particular from 3% to 30%, of at least one impact modifier;
d) from 0 to 30%, in particular from 0 to 15%, of a filler;
e) from 0 to 15%, in particular from 0.1% to 10%, notably from 0.5% to 5%, of at least one additive;
the sum of the components a+b+c+d+e is equal to 100%,
the inherent viscosity of said composition, as determined according to ISO 307:2007 in m-cresol at 20° C., being greater than or equal to 1.2 dl/g, notably in the range from 1.2 dl/g to 1.7 dl/g.

The Inventors have thus found that adding a recycled polyamide PA2 derived from used or end-of-life pipes used for the exploitation of onshore or offshore oil or gas deposits, in particular offshore deposits, to a virgin polyamide PA1 to obtain an extrudable composition without releasing noxious or toxic gases (safety for the manipulator), for the production of all types of extruded parts which do not exude or which exhibit low exudation. The compositions of the invention have good mechanical properties, allowing improved quality and productivity of welds between two parts.

The exploitation of offshore or onshore oil or gas deposits uses flexible pipes to connect the various offshore or onshore devices, respectively, of the platform and for conveying the extracted hydrocarbons.

These pipes must withstand oil which is hot, gas, water and mixtures of at least two of these products for periods of time which may be up to 20 years.

The term “used” means that the pipe has already been used in the exploitation of oil or gas deposits, whether offshore or onshore, but has not yet reached its operating limit of up to 20 years. When a platform ceases production and is dismantled, this type of pipe, which has has not yet reached the end of its useful life, needs to be recycled.

The term “end-of-life” means that the pipe has been used in the exploitation of oil or gas deposits, whether offshore or onshore, but has reached its operating limit of up to 20 years. These pipes must therefore be removed from the operating system before they are totally degraded, or before they have a leaktightness problem with respect to the oil or gas being transported.

### As Regards the Semicrystalline Aliphatic Polyamide PA1

The polyamide PA1 may be a homopolyamide or a copolyamide or a mixture thereof.

The term “semicrystalline aliphatic polyamide” means a material which is generally solid at room temperature and which softens during a temperature increase, in particular after passing its glass transition temperature (Tg), and which can melt sharply when passing its “melting temperature” (Tm), and which becomes solid again when the temperature decreases below its crystallization temperature.

The Tg, the Tc and the Tm are determined by differential scanning calorimetry (DSC) according to the standards 11357-2:2013 and 11357-3:2013, respectively.

The number-average molecular mass Mn of said semicrystalline polyamide is preferably in a range extending from 10 000 to 85 000, notably from 10 000 to 60 000, preferentially from 10 000 to 50 000, even more preferentially from 12 000 to 50 000.

The nomenclature used to define polyamides is described in the standard ISO 1874-1:2011 “Plastics—Polyamide (PA) molding and extrusion materials—Part 1: Designation”, in particular on page 3 (Tables 1 and 2), and is well known to a person skilled in the art.

Said at least one semicrystalline aliphatic polyamide PA1 may be obtained from the polycondensation of at least one lactam, or from the polycondensation of at least one amino acid, or from the polycondensation of at least one diamine X with at least one dicarboxylic acid Y or mixtures thereof.

When said at least one aliphatic semicrystalline polyamide PA1 is obtained from the polycondensation of at least one lactam, said at least one lactam may be chosen from a C6 to C18, C8 to C18, preferentially C10 to C18, more preferentially C10 to C12 lactam. A C6 to C18 lactam is notably caprolactam, decanolactam, undecanolactam or lauryllactam.

When said at least one aliphatic semicrystalline polyamide PA1 is obtained from the polycondensation of at least one lactam, it may thus comprise a single lactam or several lactams.

Advantageously, said at least one aliphatic semicrystalline polyamide PA1 is obtained from the polycondensation of a single lactam and said lactam is chosen from lauryllactam and undecanolactam, advantageously lauryllactam.

When said at least one aliphatic semicrystalline polyamide PA1 is obtained from the polycondensation of at least one amino acid, said at least one amino acid may be chosen from a C8 to C18, preferentially C10 to C18, more preferentially C10 to C12 amino acid.

A C8 to C18 amino acid is notably 9-aminononanoic acid, 10-aminodecanoic acid, 10-aminoundecanoic acid, 12-aminododecanoic acid and 11-aminoundecanoic acid, and also derivatives thereof, notably N-heptyl-11-aminoundecanoic acid.

When said at least one aliphatic semicrystalline polyamide PA1 is obtained from the polycondensation of at least one amino acid, it may thus comprise a single amino acid or several amino acids.

Advantageously, said aliphatic semicrystalline polyamide PA1 is obtained from the polycondensation of a single amino acid and said amino acid is chosen from 10-aminodecanoic acid, 11-aminoundecanoic acid and 12-aminododecanoic acid, advantageously 11-aminoundecanoic acid.

When said at least one semicrystalline aliphatic polyamide PA1 is obtained from the polycondensation of at least one diamine X with at least one aliphatic dicarboxylic acid Y, the diamine X is C4-C36, preferentially C6-C18, preferentially C6-C12, more preferentially C10-C12 and said aliphatic dicarboxylic acid Y is C6-C36, preferentially C6-C18, preferentially C6-C12, more preferentially C10-C12.

The diamine may be linear or branched. Advantageously, it is linear.

Said at least one C4-C36 diamine X may be chosen in particular from 1,4-butanediamine, 1,5-pentamethylenediamine, 1,6-hexamethylenediamine, 1,7-heptamethylenediamine, 1,8-octamethylenediamine, 1,9-nonamethylenediamine, 1,10-decamethylenediamine, 1,11-undecamethylenediamine, 1,12-dodecamethylenediamine, 1,13-tridecamethylenediamine, 1,14-tetradecamethylenediamine, 1,16-hexadecamethylenediamine and 1,18-octadecamethylenediamine, octadecenediamine, eicosanediamine, docosanediamine and diamines obtained from fatty acids.

Advantageously, said at least one diamine X is C4-C18 and chosen from 1,4-butanediamine, 1,5-pentamethylenediamine, 1,6-hexamethylenediamine, 1,7-heptamethylenediamine, 1,8-octamethylenediamine, 1,9-nonamethylenediamine, 1,10-decamethylenediamine, 1,11-undecamethylenediamine, 1,12-dodecamethylenediamine, 1,13-tridecamethylenediamine, 1,14-tetradecamethylenediamine, 1,16-hexadecamethylenediamine and 1,18-octadecamethylenediamine.

Advantageously, said at least one C6 to C12 diamine X is chosen in particular from 1,6-hexamethylenediamine, 1,7-heptamethylenediamine, 1,8-octamethylenediamine, 1,9-nonamethylenediamine, 1,10-decamethylenediamine, 1,11-undecamethylenediamine and 1,12-dodecamethylenediamine.

Advantageously, said at least one C6 to C12 diamine X is chosen in particular from 1,6-hexamethylenediamine, 1,7-heptamethylenediamine, 1,8-octamethylenediamine, 1,9-nonamethylenediamine, 1,10-decamethylenediamine, 1,11-undecamethylenediamine and 1,12-dodecamethylenediamine.

Advantageously, the diamine X used is a C10 to C12 diamine, in particular chosen from 1,10-decamethylenediamine, 1,11-undecamethylenediamine and 1,12-dodecamethylenediamine.

Said at least one C6 to C36 dicarboxylic acid Y may be chosen from adipic acid, suberic acid, azelaic acid, sebacic acid, undecanedioic acid, dodecanedioic acid, brassylic acid, tetradecanedioic acid, pentadecanedioic acid, hexadecanedioic acid, octadecanedioic acid, and diacids obtained from fatty acids.

The diacid may be linear or branched. Advantageously, it is linear.

Advantageously, said at least one dicarboxylic acid Y is a C6 to C18 dicarboxylic acid and is chosen from adipic acid, suberic acid, azelaic acid, sebacic acid, undecanedioic acid, dodecanedioic acid, brassylic acid, tetradecanedioic acid, pentadecanedioic acid, hexadecanedioic acid and octadecanedioic acid.

Advantageously, said at least one dicarboxylic acid Y is a C6 to C12 dicarboxylic acid and is chosen from adipic acid, suberic acid, azelaic acid, sebacic acid, undecanedioic acid and dodecanedioic acid.

Advantageously, said at least one dicarboxylic acid Y is C10 to C12 dicarboxylic acid and is chosen from sebacic acid, undecanedioic acid and dodecanedioic acid.

When said aliphatic semicrystalline polyamide PA1 is obtained from the polycondensation of at least one diamine X with at least one dicarboxylic acid Y, it may then comprise a single diamine or several diamines and a single dicarboxylic acid or several dicarboxylic acids.

Advantageously, said aliphatic semicrystalline polyamide PA1 is obtained from the polycondensation of a single diamine X with a single dicarboxylic acid Y.

In one embodiment, the recycled semicrystalline aliphatic polyamide PA1 is a long-chain polyamide with an average number of carbon atoms per nitrogen atom greater than 7, in particular greater than 9.

### As Regards the Recycled Semicrystalline Aliphatic Polyamide PA2

The polyamide PA2 may be a homopolyamide or a copolyamide or a mixture thereof.

The term “semicrystalline aliphatic polyamide” means a material which is generally solid at room temperature and which softens during a temperature increase, in particular after passing its glass transition temperature (Tg), and which can melt sharply when passing its “melting temperature” (Tm), and which becomes solid again when the temperature decreases below its crystallization temperature.

The Tg, the Tc and the Tm are determined by differential scanning calorimetry (DSC) according to the standards 11357-2:2013 and 11357-3:2013, respectively.

The number-average molecular mass Mn of said semicrystalline polyamide is preferably in a range extending from 10 000 to 85 000, notably from 10 000 to 60 000, preferentially from 10 000 to 50 000, even more preferentially from 12 000 to 50 000.

Said at least one semicrystalline aliphatic polyamide PA2 was initially obtained before use in the exploitation of oil or gas deposits from the polycondensation of at least one lactam, or from the polycondensation of at least one amino acid, or from the polycondensation of at least one diamine X with at least one dicarboxylic acid Y or mixtures thereof as described above for the semicrystalline aliphatic polyamide PAL.

Advantageously, PA 2 is a PA 11 or PA 12, in particular PA11.

After use, i.e. when it is spent or at the end of its life, the pipe used for the exploitation of offshore or onshore oil or gas deposits, in particular offshore deposits, is removed from the drilling platform, the various layers are separated and the layers containing PA 2 are ground in the form of ground material (0.5 mm to 25 mm) or powder (to a size below 0.5 mm) and then washed and/or compounded, i.e. the shreds, after washing or not, are placed at least once in an extruder, notably of the twin-screw co-rotating type, or of the co-kneader (Buss) type, where the shreds are remixed by melting, with or without the addition of at least one catalyst. The molten material exits the extruder as rods which are cooled and cut into granules.

Advantageously, the number of compounding operations is 1 to 10, in particular 1 to 5; the number of compounding operations is notably 1, 2, 3, 4 or 5, in particular 1, 2 or 3.

When necessary, the shreds may be washed notably using a solvent, in particular methanol or ethanol, so as to extract the vast majority of pollutants, as described below, coming from the exploitation.

When necessary, the compounding may be performed with addition of a catalyst.

The term “catalyst” denotes a polycondensation catalyst such as a mineral or organic acid.

Advantageously, the weight proportion of catalyst is from about 50 ppm to about 5000 ppm, in particular from about 100 to about 3000 ppm, relative to the total weight of the composition.

Advantageously, the catalyst is chosen from phosphoric acid (H3PO4), phosphorous acid (H3PO3) and hypophosphorous acid (H3PO2), or a mixture thereof.

Advantageously, the present invention thus relates to the use defined above of at least one catalyst, in a weight proportion of catalyst from about 50 ppm to about 5000 ppm, in particular from about 100 to about 3000 ppm, relative to the total weight of the composition, of at least one copper-based heat stabilizer and of at least one oligo- or poly-carbodiimide, with a matrix comprising at least one thermoplastic polymer, notably a polyamide, said catalyst being chosen from phosphoric acid (H3PO4), phosphorous acid (H3PO3), hypophosphorous acid (H3PO2) or a mixture thereof.

Advantageously, the catalyst is chosen from phosphoric acid (H3PO4), phosphorous acid (H3PO3) in a proportion from about 100 to about 3000 ppm.

In one embodiment, the PA2 mixture to be recycled is degassed during compounding.

In one embodiment, the degassing is weak, meaning that the degassing ranges from −50 mmHg to −150 mmHg.

For example, it is performed according to the following protocol A:
the washed or unwashed ground pipe is compounded on a Coperion/Werner 40 mm twin-screw extruder, 70 kg/h, 300 rpm, 270° C. set point, with −100 mmHg degassing.

In another embodiment, the degassing is strong, meaning that the degassing ranges from −550 mmHg to −750 mmHg.

For example, it is performed according to the following protocol B:
the washed or unwashed ground pipe is compounded on a Coperion/Werner 40 mm twin-screw extruder, 70 kg/h, 300 rpm, 270° C. set point, with strong degassing of −660 mmHg.

Advantageously, degassing takes place just after the melt zone in the extruder.

The inherent viscosity of the semicrystalline aliphatic polyamide after grinding and washing or after grinding and compounding with or without catalyst, or else after grinding, washing and compounding with or without catalyst, as determined according to ISO 307:2007 in m-cresol at 20° C., is greater than or equal to 1.2 dl/g, notably in the range from 1.2 dl/g to 1.7 dl/g.

The ground, washed and/or compounded semicrystalline aliphatic polyamide, with or without catalyst, with or without degassing, thus corresponds to the recycled semicrystalline aliphatic polyamide PA2 of the composition of the invention.

In one embodiment, the recycled semicrystalline aliphatic polyamide PA2 is a long-chain polyamide having an average number of carbon atoms per nitrogen atom of greater than 7, in particular greater than 9.

In particular, the recycled semicrystalline aliphatic polyamide PA2 is a long-chain polyamide having an average number of carbon atoms per nitrogen atom of more than 7 to 12, notably more than 7 to 11, in particular more than 9 to 12, notably more than 9 to 11.

In another embodiment, said recycled semicrystalline aliphatic polyamide PA2 comprises at least one species chosen from alkanes, aliphatic C14 to C18 monoacids, mono- or poly-aromatic compounds and aromatic acids.

The alkanes are notably methylcyclopentane, cyclohexane, methylcyclohexane, 1,2-cis-dimethylcyclohexane, 1,2-trans-dimethylcyclohexane, 1,3-cis-dimethylcyclohexane, 1,3-trans-dimethylcyclohexane, 1,4-cis-dimethylcyclohexane, 1,4-trans-dimethylcyclohexane or ethylcyclohexane.

The C14 to C18 aliphatic monoacids are notably palmitic acid and stearic acid.

Said C14 to C18 aliphatic monoacids are also present in the initial virgin semicrystalline aliphatic polyamide (from 1 to 100 ppm) but are present in greater concentration in the recycled semicrystalline aliphatic polyamide PA2 (more than 100 ppm), notably from 500 to 5000 ppm.

The mono- or poly-aromatic compounds are notably toluene, xylene, trimethylbenzene, diphenylmethane, diphenylmethanol, naphthalene, 1-methylnaphthalene, 2-methylnaphthalene, 1,2-dimethylnaphthalene, 1,3-dimethylnaphthalene, 1,4-dimethylnaphthalene, 1,3,6-trimethylnaphthalene, 2,3,5-trimethylnaphthalene, 1-phenanthrene and 2-methylphenanthrene.

The aromatic acids are notably benzoic acid, 2-methylbenzoic acid, 3-methylbenzoic acid, 4-methylbenzoic acid, 2,5-dimethylbenzoic acid, 3,4-dimethylbenzoic acid, 2,4-dimethylbenzoic acid and 3,5-dimethylbenzoic acid.

Advantageously, said recycled semicrystalline aliphatic polyamide PA2 comprises at least one species chosen from sulfur compounds, alkanes, C14 to C18 aliphatic monoacids, mono- or poly-aromatic compounds and aromatic acids.

More advantageously, said recycled semicrystalline aliphatic polyamide PA2 comprises at least one species chosen from alkanes, mono- or poly-aromatic compounds and aromatic acids.

Even more advantageously, said recycled semicrystalline aliphatic polyamide PA2 comprises at least one species chosen from alkanes and mono- or poly-aromatic compounds.

Advantageously, said recycled semicrystalline aliphatic polyamide PA2 comprises at least one species chosen from alkanes such as methylcyclopentane, cyclohexane, methylcyclohexane, 1,2-cis-dimethylcyclohexane, 1,2-trans-dimethylcyclohexane, 1,3-cis-dimethylcyclohexane, 1,3-trans-dimethylcyclohexane, 1,4-cis-dimethylcyclohexane, 1,4-trans-dimethylcyclohexane, or ethylcyclohexane and mono- or polyaromatic compounds such as toluene, xylene, trimethylbenzene, diphenylmethane, diphenylmethanol, naphthalene, 1-methylnaphthalene, 2-methylnaphthalene, 1,2-dimethylnaphthalene, 1,3-dimethylnaphthalene, 1,4-dimethylnaphthalene, 1,3,6-trimethylnaphthalene, 2,3,5-trimethylnaphthalene, 1-phenanthrene and 2-methylphenanthrene.

Advantageously, said recycled semicrystalline aliphatic polyamide PA2 comprises at least one species chosen from bitumens in a content of between 0.1 and 500 ppm.

In one embodiment, the total mass content of said species present in the recycled semicrystalline aliphatic polyamide PA2 ranges from 1 ppm to 2000 ppm, for example from 10 ppm to 2000 ppm, for example from 50 ppm to 2000 ppm, for example from 100 ppm to 2000 ppm, in particular from 100 ppm to 1000 ppm, for example from 100 ppm to 700 ppm, for example from 100 ppm to 400 ppm. Preferably, the total mass content of said species present in the recycled PA2 semicrystalline aliphatic polyamide ranges from 10 ppm to 700 ppm, for example from 50 ppm to 400 ppm.

In one embodiment, the mass content for each alkane in the recycled semicrystalline aliphatic polyamide PA2 is between 0.1 and 400 ppm, preferably between 1 and 150 ppm.

In one embodiment, the mass content for each aromatic compound in the recycled semicrystalline aliphatic polyamide PA2 ranges between 0.1 and 600 ppm, preferably between 1 and 300 ppm, notably from 5 to 100 ppm.

The alkanes and aromatic molecules are analyzed by thermo-desorption (dynamic headspace at 300° C., for 60 minutes) coupled with gas chromatography (C18 column) fitted with flame ionization detection and a mass spectrometer equipped with an electron impact (EI) source. Quantification is performed in pentadecane equivalent.

In one embodiment, the mass content for each acidic aromatic compound in the recycled semicrystalline aliphatic polyamide PA2 is between 0.1 and 600 ppm, preferably between 1 and 300 ppm, notably from 5 to 100 ppm.

In one embodiment, the mass content for each monoacid compound in the recycled semicrystalline aliphatic polyamide PA2 is between 0.1 and 600 ppm, preferably between 1 and 300 ppm, notably from 5 to 100 ppm.

For the quantification of the acidic aromatic compounds or monoacids, methanol extraction is required, followed by methylation derivatization on the dry extracts to enhance detection. Analysis is performed by gas chromatography (C18 column) fitted with flame ionization detection and a mass spectrometer equipped with an electron impact source. Quantification is performed in pentadecane equivalent.

In another embodiment, the recycled semicrystalline aliphatic polyamide PA2 has a characteristic odor comprising sulfur/pyrogen and/or hydrocarbon and/or aromatic, terpene and phenol notes.

The above odors are determined according to Jean-Noël Jaubert's description of the Odor Field®.

The odor field, developed in 1983, provides, inter alia, a methodology that enables olfactory perceptions to be described in a common manner, i.e. by dispensing, as far as possible, with individual evocations. It was created by a researcher, Jean-Noël Jaubert, based on the results of a research program into the chemical structure/odorant activity relationship of molecules present in the odorant world. Initially developed for the fragrance industry, this method has made it possible to describe, analyze, compare and control complete products or odorant preparations beyond the usual classifications.

The drawback associated with the odor problems is a signature of a recycled polyamide.

This drawback is perceived when opening the containers of washed or unwashed shreds, or during extrusion and possibly on the finished product.

Recycled polyamides have sulfur or aromatic odor notes (aromatic solvent odor, naphthalene). It is clearly possible to smell a difference between a virgin polyamide and a recycled polyamide.

In yet another embodiment, the recycled semicrystalline aliphatic polyamide PA2 contains functions resulting from thermolysis reactions in an acidic medium, notably amide functions and/or methylene alpha to said amide functions and acid chain ends, chosen from nitrile functions, ketone functions and ester functions resulting from the reaction of the acid functions of the polyamide with alcohols used during the life of said pipes, in a mole ratio relative to the amide functions greater than that of the same polyamide constituting an unused pipe.

In one embodiment, the mole ratio of functions derived from thermolysis reactions is from 1/10 000 to 1/20, as determined by proton NMR.

The concentrations may be measured by proton NMR in dichloromethane-d2, with the addition of HFIP (hexafluoroisopropanol) to dissolve the polyamide.

During petroleum extraction, alcohols such as ethanol are used, which may react with the acid functions initially present in the semicrystalline aliphatic polyamide to form ester functions.

In one embodiment, said recycled semicrystalline aliphatic polyamide PA2 has a content of cyclic oligomers, chosen from oligomers with a molar mass of less than 1000 g/mol, lower than that of the equivalent virgin polyamide.

The cyclic oligomer content is measured according to the following protocol:

The recycled semicrystalline aliphatic polyamide PA2 granules are dissolved in an HFIP (CAS RN 920-66-1)/CH2CI2 (CAS RN 75-09-3) mixture and a nonsolvent (methanol CAS RN 67-56-1) is then added. The low molar masses are thus dissolved and the high molar masses precipitate.

This solution is filtered at 200 μm before analysis.

The oligomers are evaluated as lactam-12 equivalents by reverse-phase liquid chromatography-mass spectrometry using positive electrospray ionization. Formic acid is added to improve ionization.

A peak distribution is observed due to the different molar masses (from monomer to pentamer with linear or cyclic forms).

As a result firstly of fluid transport, and secondly of being washed, the polyamide has fewer oligomers than the same virgin semicrystalline aliphatic polyamide, since said transport and washing extract cyclic oligomers.

Advantageously, said recycled semicrystalline aliphatic polyamide PA2 has a content of cyclic oligomers, chosen from oligomers with a molar mass of less than 1000 g/mol, of less than 90% by weight, notably less than 50% by weight, notably less than 20% by weight, in particular less than 10% by weight, relative to that of the equivalent virgin polyamide.

Advantageously, said recycled semicrystalline aliphatic polyamide PA2 has a higher content of linear oligomer than that of a virgin PA.

The weight content of cyclic oligomer in a virgin polyamide ranges from 500 to 10 000 ppm for each cyclic species from monomer to pentamer (preferentially having a mass of less than 1000 g·mol⁻¹), the cyclic dimer in particular being the predominant species.

In particular, the content of cyclic oligomer with a mass of less than 1000 g·mol⁻¹ is a maximum of 4% by weight in virgin polyamide.

In one embodiment, said recycled semicrystalline aliphatic polyamide PA2 has a content of cyclic oligomers with a molar mass below 1000 g/mol, ranging from 50 to 5000 ppm for each cyclic species from monomer to pentamer, but in any case lower than that of the equivalent virgin polyamide.

The weight content of linear oligomer in a virgin polyamide ranges from 200 to 2000 ppm for each linear species from monomer to pentamer (preferentially having a mass of less than 1000 g·mol⁻¹).

In one embodiment, said recycled semicrystalline aliphatic polyamide PA2 has a content of linear oligomers with a molar mass below 1000 g/mol, ranging from 250 to 5000 ppm for each cyclic species from monomer to pentamer, but in any case greater than that of the equivalent virgin polyamide.

In one embodiment, said recycled semicrystalline aliphatic polyamide PA2 has a weight content of alkyl chain ends ranging from 1 ppm to 5000 ppm, advantageously 10 to 2500 ppm, said alkyl being C1 to C18 and said content being higher than that of a virgin semicrystalline aliphatic polyamide.

### As Regards the Composition

In a first variant, the extrusion composition according to the invention comprises, by weight:
a) from 35% to 100%, in particular from 35% to 96.9%, of at least one semicrystalline aliphatic polyamide PA1 comprising at least 30%, in particular at least 50%, of recycled semicrystalline aliphatic polyamide PA2 originating from used or end-of-life pipes which have been used in the exploitation of offshore or onshore oil or gas deposits, in particular offshore deposits, said recycled semicrystalline aliphatic polyamide PA2 having undergone a washing and/or compounding step after removal and grinding in the form of granules of said pipe;
b) from 0 to 65%, in particular from 0 to 10%, of at least one reinforcing fiber;
c) from 0 to 40%, in particular from 3% to 30%, of at least one impact modifier;
d) from 0 to 30%, in particular from 0 to 15%, of a filler;
e) from 0 to 10%, in particular from 0.1% to 5%, of at least one additive;
the sum of the components a+b+c+d+e is equal to 100%.

Said composition is an extrusion composition and is not an injection composition, i.e. it is not a molding composition.

In one embodiment of this first variant, said extrusion composition according to the invention comprises by weight:
a) from 35% to 97%, in particular from 35% to 96.9% of at least one semicrystalline aliphatic polyamide PA1 comprising at least 30%, in particular at least 50%, of recycled semicrystalline aliphatic polyamide PA2 originating from used or end-of-life pipes which have been used in the exploitation of offshore or onshore oil or gas deposits, in particular offshore deposits, said recycled semicrystalline aliphatic polyamide PA2 having undergone a washing and/or compounding step after removal and grinding in the form of granules of said pipe;
b) from 0 to 65%, in particular from 0 to 10%, of at least one reinforcing fiber;
c) from 3% to 30% of at least one impact modifier;
d) from 0 to 30%, in particular from 0 to 15%, of a filler;
e) from 0 to 10%, in particular from 0.1% to 5%, of at least one additive;
the sum of the components a+b+c+d+e is equal to 100%.

In another embodiment of this first variant, said extrusion composition according to the invention comprises by weight:
a) from 35% to 96.9% of at least one semicrystalline aliphatic polyamide PA1 comprising at least 30%, in particular at least 50%, of recycled semicrystalline aliphatic polyamide PA2 originating from used or end-of-life pipes which have been used in the exploitation of offshore or onshore oil or gas deposits, in particular offshore deposits, said recycled semicrystalline aliphatic polyamide PA2 having undergone a washing and/or compounding step after removal and shredding into granules of said pipe;
b) from 0 to 65%, in particular from 0 to 10%, of at least one reinforcing fiber;
c) from 3% to 30% of at least one impact modifier;
d) from 0 to 30%, in particular from 0 to 15%, of a filler;
e) from 0.1% to 5% of at least one additive,
the sum of the components a+b+c+d+e is equal to 100%.

Advantageously, in this first variant and its two embodiments, said composition consists of said constituents.

In a second variant, said extrusion composition comprises by weight:
a) from 35% to 100%, in particular from 35% to 96.9%, of at least one semicrystalline aliphatic polyamide PA1 comprising at least 30%, in particular at least 50%, of recycled semicrystalline aliphatic polyamide PA2 originating from used or end-of-life pipes which have been used in the exploitation of offshore or onshore oil or gas deposits, in particular offshore deposits, said recycled semicrystalline aliphatic polyamide PA2 having undergone a washing and/or compounding step after removal and shredding in the form of granules of said pipe;
c) from 0 to 40%, in particular from 3% to 30%, of at least one impact modifier;
d) from 0 to 30%, in particular from 0 to 15%, of a filler;
e) from 0 to 10%, in particular from 0.1% to 5%, of at least one additive;
the sum of the components a+c+d+e is equal to 100%.

In one embodiment of this second variant, reinforcing fibers are excluded from said extrusion composition according to the invention.

In one embodiment of this second variant, said extrusion composition according to the invention comprises by weight:
a) from 35% to 97% of at least one semicrystalline aliphatic polyamide PA1 comprising at least 30%, in particular at least 50%, of recycled semicrystalline aliphatic polyamide PA2 originating from used or end-of-life pipes which have been used in the exploitation of offshore or onshore oil or gas deposits, in particular offshore deposits, said recycled semicrystalline aliphatic polyamide PA2 having undergone a washing and/or compounding step after removal and shredding into granules of said pipe;
c) from 3% to 30% of at least one impact modifier;
d) from 0 to 30%, in particular from 0 to 15%, of a filler;
e) from 0 to 10%, in particular from 0.1% to 5%, of at least one additive;
the sum of the components a+b+c+d+e is equal to 100%.

In another embodiment of this second variant, said extrusion composition according to the invention comprises by weight:
a) from 35% to 96.9% of at least one semicrystalline aliphatic polyamide PA1 comprising at least 30%, in particular at least 50%, of recycled semicrystalline aliphatic polyamide PA2 originating from used or end-of-life pipes which have been used in the exploitation of offshore or onshore oil or gas deposits, in particular offshore deposits, said recycled semicrystalline aliphatic polyamide PA2 having undergone a washing and/or compounding step after removal and shredding into granules of said pipe;
c) from 3% to 30% of at least one impact modifier;
d) from 0 to 30%, in particular from 0 to 15%, of a filler;
e) from 0.1% to 5% of at least one additive,
the sum of the components a+b+c+d+e is equal to 100%.

Advantageously, in this second variant and its two embodiments, said composition consists of said constituents.

In one embodiment of these two variants and embodiments associated therewith, said extrusion composition defined above has a characteristic odor comprising sulfur and/or hydrocarbon and/or aromatic notes as described in Jean-Noël Jaubert's odor Field®.

In one embodiment of these two variants and combinations associated therewith, said semicrystalline aliphatic polyamide PA1 comprises at least 40% of recycled semicrystalline aliphatic polyamide PA2 from used or end-of-life pipes which have been used in the exploitation of offshore or onshore oil or gas deposits, in particular offshore deposits.

Advantageously, said semicrystalline aliphatic polyamide PA1 comprises at least 50% of said recycled semicrystalline aliphatic polyamide PA2.

Advantageously, said semicrystalline aliphatic polyamide PA1 comprises at least 60% of said recycled semicrystalline aliphatic polyamide PA2.

Advantageously, said semicrystalline aliphatic polyamide PA1 comprises at least 70% of said recycled semicrystalline aliphatic polyamide PA2.

Advantageously, said semicrystalline aliphatic polyamide PA1 comprises at least 80% of said recycled semicrystalline aliphatic polyamide PA2.

Advantageously, said semicrystalline aliphatic polyamide PA1 comprises at least 90% of said recycled semicrystalline aliphatic polyamide PA2.

In these last six embodiments, said semicrystalline aliphatic polyamide PA1 is constituted of said semicrystalline aliphatic polyamide PA2 in the proportions described.

According to any one of the embodiments of the invention, the extrusion composition of the invention may comprise at least one species chosen from alkanes, aliphatic C14 to C18 monoacids, mono- or poly-aromatic compounds and aromatic acids.

The alkanes are notably methylcyclopentane, cyclohexane, methylcyclohexane, 1,2-cis-dimethylcyclohexane, 1,2-trans-dimethylcyclohexane, 1,3-cis-dimethylcyclohexane, 1,3-trans-dimethylcyclohexane, 1,4-cis-dimethylcyclohexane, 1,4-trans-dimethylcyclohexane or ethylcyclohexane.

The C14 to C18 aliphatic monoacids are notably palmitic acid and stearic acid.

The mono- or poly-aromatic compounds are notably toluene, xylene, trimethylbenzene, diphenylmethane, diphenylmethanol, naphthalene, 1-methylnaphthalene, 2-methylnaphthalene, 1,2-dimethylnaphthalene, 1,3-dimethylnaphthalene, 1,4-dimethylnaphthalene, 1,3,6-trimethylnaphthalene, 2,3,5-trimethylnaphthalene, 1-phenanthrene and 2-methylphenanthrene.

The aromatic acids are notably benzoic acid, 2-methylbenzoic acid, 3-methylbenzoic acid, 4-methylbenzoic acid, 2,5-dimethylbenzoic acid, 3,4-dimethylbenzoic acid, 2,4-dimethylbenzoic acid and 3,5-dimethylbenzoic acid.

Advantageously, the extrusion composition of the invention comprises at least one species chosen from sulfur compounds, alkanes, aliphatic C14 to C18 monoacids, mono- or poly-aromatic compounds and aromatic acids.

More advantageously, the extrusion composition of the invention comprises at least one species chosen from alkanes, mono- or polyaromatic compounds and aromatic acids.

Even more advantageously, the extrusion composition of the invention comprises at least one species chosen from alkanes and mono- or polyaromatic compounds.

Advantageously, the extrusion composition of the invention comprises at least one species chosen from alkanes such as methylcyclopentane, cyclohexane, methylcyclohexane, 1,2-cis-dimethylcyclohexane, 1,2-trans-dimethylcyclohexane, 1,3-cis-dimethylcyclohexane, 1,3-trans-dimethylcyclohexane, 1,4-cis-dimethylcyclohexane, 1,4-trans-dimethylcyclohexane or ethylcyclohexane, and mono- or polyaromatic compounds such as toluene, xylene, trimethylbenzene, diphenylmethane, diphenylmethanol, naphthalene, 1-methylnaphthalene, 2-methylnaphthalene, 1,2-dimethylnaphthalene, 1,3-dimethylnaphthalene, 1,4-dimethylnaphthalene, 1,3,6-trimethylnaphthalene, 2,3,5-trimethylnaphthalene, 1-phenanthrene and 2-methylphenanthrene.

Advantageously, the extrusion composition of the invention comprises at least one species chosen from bitumens in a content of between 0.1 and 500 ppm.

In one embodiment, the total mass content of said species present in the extrusion composition of the invention ranges from 0.1 ppm to 2000 ppm, for example from 1 ppm to 1000 ppm, for example from 10 ppm to 300 ppm, for example from 20 ppm to 250 ppm, in particular from 30 ppm to 150 ppm. Preferably, the total mass content of said species present in the composition of the invention ranges from 1 ppm to 300 ppm, for example from 100 ppm to 150 ppm.

In one embodiment, the mass content for each alkane in the extrusion composition of the invention is between 0.1 and 400 ppm, preferably between 1 and 150 ppm.

In one embodiment, the mass content for each aromatic compound in the extrusion composition of the invention is between 0.1 and 300 ppm, preferably between 1 and 150 ppm, notably from 5 to 100 ppm.

The alkanes and aromatic molecules are analyzed by thermo-desorption (dynamic headspace at 300° C., for 60 minutes) coupled with gas chromatography (C18 column) fitted with flame ionization detection and a mass spectrometer equipped with an electron impact (EI) source. Quantification is performed in pentadecane equivalent.

In one embodiment, the mass content for each acidic aromatic compound in the extrusion composition of the invention is between 0.1 and 300 ppm, preferably between 1 and 150 ppm, notably from 5 to 100 ppm.

In one embodiment, the mass content for each monoacid compound in the extrusion composition of the invention is between 0.1 and 600 ppm, preferably between 1 and 300 ppm, notably from 5 to 100 ppm.

For the quantification of the acidic aromatic compounds or monoacids, methanol extraction is required, followed by methylation derivatization on the dry extracts to enhance detection. Analysis is performed by gas chromatography (C18 column) fitted with flame ionization detection and a mass spectrometer equipped with an electron impact source. Quantification is performed in pentadecane equivalent.

According to any one of the embodiments of the invention, the extrusion composition of the invention may have a content of cyclic oligomers, chosen from oligomers with a molar mass of less than 1000 g/mol, lower than that of the equivalent virgin polyamide.

The cyclic oligomer content is measured according to the following protocol:

The granules of the extrusion composition of the invention are dissolved in an HFIP (CAS RN 920-66-1)/CH2CI2 (CAS RN 75-09-3) mixture and a nonsolvent (methanol CAS RN 67-56-1) is then added. The low molar masses are thus dissolved and the high molar masses precipitate.

This solution is filtered at 200 μm before analysis.

The oligomers are evaluated as lactam-12 equivalents by reverse-phase liquid chromatography-mass spectrometry using positive electrospray ionization. Formic acid is added to improve ionization.

A peak distribution is observed due to the different molar masses (from monomer to pentamer with linear or cyclic forms).

As a result firstly of fluid transport, and secondly of being washed, the polyamide has fewer oligomers than the same virgin semicrystalline aliphatic polyamide, since said transport and washing extract cyclic oligomers.

Advantageously, the extrusion composition of the invention has a content of cyclic oligomers, chosen from oligomers with a molar mass of less than 1000 g/mol, of less than 90% by weight, notably less than 50% by weight, notably less than 20% by weight, in particular less than 10% by weight, compared with that of an identical extrusion composition comprising, instead of recycled semicrystalline aliphatic polyamide PA2, an equivalent virgin polyamide.

Advantageously, the extrusion composition of the invention has a content of linear oligomer higher than that of an identical extrusion composition comprising, instead of recycled semicrystalline aliphatic polyamide PA2, an equivalent virgin polyamide.

The weight content of cyclic oligomer in a virgin polyamide ranges from 500 to 10 000 ppm for each cyclic species from monomer to pentamer (preferentially having a mass of less than 1000 g·mol⁻¹), the cyclic dimer in particular being the predominant species.

In particular, the content of cyclic oligomer with a mass of less than 1000 g·mol⁻¹ is a maximum of 4% by weight in virgin polyamide.

In one embodiment, the extrusion composition of the invention has a content of cyclic oligomer with a molar mass of less than 1000 g/mol ranging from 50 to 5000 ppm for each cyclic species from monomer to pentamer, but in any case it is lower than that of an identical extrusion composition comprising, instead of recycled semicrystalline aliphatic polyamide PA2, an equivalent virgin polyamide.

The weight content of linear oligomer in the extrusion composition of the invention ranges from 200 to 2000 ppm for each linear species from monomer to pentamer (preferentially with a mass of less than 1000 g·mol⁻¹).

In one embodiment, the extrusion composition of the invention has a content of linear oligomers with a molar mass of less than 1000 g/mol, ranging from 250 to 5000 ppm for each cyclic species from monomer to pentamer, but in any case it is higher than that of an identical extrusion composition comprising, instead of recycled semicrystalline aliphatic polyamide PA2, an equivalent virgin polyamide.

In one embodiment, the extrusion composition of the invention comprises a weight content of alkyl chain ends ranging from 1 ppm to 5000 ppm, advantageously 10 to 2500 ppm, said alkyl being C1 to C18 and said content being higher than that of an identical extrusion composition comprising, instead of recycled semicrystalline aliphatic polyamide PA2, an equivalent virgin polyamide.

### As Regards the Reinforcing Fibers (b)

As regards the reinforcing fibers, these are short fibers, which are notably fibers of mineral, organic or plant origin.

Said reinforcing fiber may or may not be sized.

Said reinforcing fibre may thus comprise up to 0.1% by weight of a material of organic nature (thermosetting or thermoplastic resin type) known as sizing.

Mention may be made, among the fibers of mineral origin, of carbon fibers, glass fibers, basalt fibers or basalt-based fibers, silica fibers or silicon carbide fibers, for example. Mention may be made, among the fibers of organic origin, of fibers based on thermoplastic or thermosetting polymer, such as semiaromatic polyamide fibers, aramid fibers or polyolefin fibers, for example. Preferably, they are based on an amorphous thermoplastic polymer and have a glass transition temperature Tg which is greater than the Tg of the constituent thermoplastic polymer or polymer blend of the preimpregnation matrix when the polymer or blend is amorphous, or which is greater than the Tm of the constituent thermoplastic polymer or polymer blend of the preimpregnation matrix when the polymer or blend is semicrystalline. Mention may be made, among the fibers of plant origin, of natural fibers based on flax, hemp, lignin, bamboo, silk, in particular spider silk, sisal, and other cellulose fibers, in particular viscose fibers. These fibers of plant origin can be used pure, treated or else coated with a coating layer, for the purpose of facilitating the adhesion and the impregnation of the thermoplastic polymer matrix.

Preferably, said reinforcing fiber is chosen from glass fibers, carbon fibers, basalt fibers and basalt-based fibers.

More advantageously, said reinforcing fiber is chosen from carbon fibers and glass fibers.

In one embodiment, the reinforcing fibers present in a) are glass fibers.

The glass fibers may be of circular or non-circular cross section.

A fiber of circular cross section is defined as a fiber having at any point on its circumference an equal distance to the center of the fiber and therefore represents a perfect or near-perfect circle.

Any glass fiber that does not have this perfect or near-perfect circle is therefore defined as a fiber of non-circular cross section.

Examples of fibers of non-circular cross section, without being limited thereto, are non-circular fibers, having for example an elliptical, oval or cocoon shape, star-shaped fibers, flake-shaped fibers, flat fibers, cruciforms, a polygon and a ring.

The glass fiber may be:
either of circular cross section with a diameter of from 4 μm to 25 μm, preferably from 4 to 15 μm;
or of non-circular cross section with an L/D ratio (L representing the largest dimension of the cross section of the fiber and D the smallest dimension of the cross section of said fiber) of from 2 to 8, in particular from 2 to 4. L and D can be measured by scanning electron microscopy (SEM).

Advantageously, the glass fibers are circular.

The glass fibers are notably of type E, R, S2 or T. Advantageously, the glass fibers are of type E.

### As Regards the Impact Modifier (c):

The impact modifier represents from 0 to 40%, in particular from 3% to 30%, of at least one impact modifier.

In one embodiment, it represents from 5% to 20%.

By way of example, the impact modifiers are polyolefins with a modulus <200 MPa, in particular <100 MPa, as measured according to the standard ISO 178:2010, at 23° C. or a thermoplastic elastomer.

In one embodiment, the impact modifier is chosen from a functionalized or non-functionalized polyolefin with a modulus <200 MPa, in particular <100 MPa, and mixtures thereof.

### The Polyolefin:

The polyolefin may be functionalized or nonfunctionalized or a blend thereof.

For simplification, the polyolefin has been denoted (B) and functionalized polyolefins (B1) and nonfunctionalized polyolefins (B2) have been described below.

A nonfunctionalized polyolefin (B2) is conventionally a homopolymer or copolymer of alpha-olefins or of diolefins, for instance ethylene, propylene, 1-butene, 1-octene or butadiene. Examples that may be mentioned include:
polyethylene homopolymers and copolymers, in particular LDPE, HDPE, LLDPE (linear low density polyethylene), VLDPE (very low density polyethylene) and metallocene polyethylene,
propylene homopolymers or copolymers,
ethylene/alpha-olefin, such as ethylene/propylene, copolymers, EPRs (abbreviation for ethylene propylene rubber) and ethylene/propylene/diene (EPDM) copolymers,
copolymers of ethylene with at least one product chosen from salts or esters of unsaturated carboxylic acids, such as alkyl (meth)acrylate (for example methyl acrylate), or vinyl esters of saturated carboxylic acids, such as vinyl acetate (EVA), it being possible for the proportion of comonomer to be up to 40% by weight.

The functionalized polyolefin (B1) may be a polymer of alpha-olefins having reactive units (the functionalities); such reactive units are acid, anhydride or epoxy functions. By way of example, mention may be made of the preceding polyolefins (B2) grafted or copolymerized or terpolymerized with unsaturated epoxides, such as glycidyl (meth)acrylate, or with carboxylic acids or the corresponding salts or esters, such as (meth)acrylic acid (it being possible for the latter to be completely or partially neutralized with metals such as Zn, etc.), or else with carboxylic acid anhydrides, such as maleic anhydride. A functionalized polyolefin is, for example, a PE/EPR mixture, the weight ratio of which can vary within broad limits, for example between 40/60 and 90/10, said mixture being cografted with an anhydride, notably maleic anhydride, in a degree of grafting of, for example, from 0.01% to 5% by weight.

The functionalized polyolefin (B1) may be chosen from the following (co)polymers, grafted with maleic anhydride or glycidyl methacrylate, in which the degree of grafting is, for example, from 0.01% to 5% by weight:
PE, PP, copolymers of ethylene with propylene, butene, hexene or octene containing, for example, from 35% to 80% by weight of ethylene;
ethylene/alpha-olefin, such as ethylene/propylene, copolymers, EPRs (abbreviation for ethylene propylene rubber) and ethylene/propylene/diene (EPDM) copolymers;
   styrene/ethylene-butene/styrene (SEBS), styrene/butadiene/styrene (SBS), styrene/isoprene/styrene (SIS) and styrene/ethylene-propylene/styrene (SEPS) block copolymers;
copolymers of ethylene and vinyl acetate (EVA), containing up to 40% by weight of vinyl acetate;
copolymers of ethylene and alkyl (meth)acrylate, containing up to 40% by weight of alkyl (meth)acrylate;
copolymers of ethylene and vinyl acetate (EVA) and alkyl (meth)acrylate, containing up to 40% by weight of comonomers.

The functionalized polyolefin (B1) may also be chosen from ethylene/propylene copolymers, predominant in propylene, grafted with maleic anhydride and then condensed with monoamino polyamide (or polyamide oligomer) (products described in EP-A-0342066).

The functionalized polyolefin (B1) may also be a copolymer or terpolymer of at least the following units: (1) ethylene, (2) alkyl (meth)acrylate or saturated carboxylic acid vinyl ester and (3) anhydride such as maleic anhydride, or (meth)acrylic acid, or epoxy, such as glycidyl (meth)acrylate.

As examples of functionalized polyolefins of the latter type, mention may be made of the following copolymers, where ethylene preferably represents at least 60% by weight and where the termonomer (the function) represents, for example, from 0.1% to 10% by weight of the copolymer:
ethylene/alkyl (meth)acrylate/(meth)acrylic acid or maleic anhydride or glycidyl methacrylate copolymers;
ethylene/vinyl acetate/maleic anhydride or glycidyl methacrylate copolymers;
ethylene/vinyl acetate or alkyl (meth)acrylate/(meth)acrylic acid or maleic anhydride or glycidyl methacrylate copolymers.

In the preceding copolymers, the (meth)acrylic acid can be salified with Zn or Li.

The term “alkyl (meth)acrylate” in (B1) or (B2) denotes C1-C8 alkyl methacrylates and acrylates and may be chosen from methyl acrylate, ethyl acrylate, n-butyl acrylate, isobutyl acrylate, 2-ethylhexyl acrylate, cyclohexyl acrylate, methyl methacrylate and ethyl methacrylate.

Moreover, the abovementioned polyolefins (B1) may also be crosslinked via any suitable process or agent (diepoxy, diacid, peroxide, etc.); the term “functionalized polyolefin” also includes mixtures of the abovementioned polyolefins with a difunctional reagent such as diacid, dianhydride, diepoxy, etc. that is capable of reacting with these polyolefins, or mixtures of at least two functionalized polyolefins that can react with each other.

The abovementioned copolymers, (B1) and (B2), may be copolymerized in random or block fashion and may have a linear or branched structure.

The molecular weight, the MFI index and the density of these polyolefins may also vary within a broad range, as those skilled in the art will appreciate. MFI is the abbreviation for the Melt Flow Index. It is measured according to the standard ISO 1133 at 235° C. under 5 kg.

Advantageously, the nonfunctionalized polyolefins (B2) are chosen from polypropylene homopolymers or copolymers and any ethylene homopolymer or copolymer of ethylene and of a comonomer of higher alpha-olefin type, such as butene, hexene, octene, or 4-methyl-1-pentene.

Mention may be made, for example, of PPs, high density PEs, medium density PEs, linear low density PEs, low density PEs or very low density PEs. These polyethylenes are known to those skilled in the art as being produced according to a “radical” process, according to a “Ziegler” type catalysis or, more recently, according to a “metallocene” catalysis.

The functionalized polyolefins (B1) are advantageously chosen from any polymer comprising α-olefin units and units bearing polar reactive functions, such as epoxy, carboxylic acid or carboxylic acid anhydride functions. By way of example of such polymers, mention may be made of terpolymers of ethylene, of alkyl acrylate and of maleic anhydride or of glycidyl methacrylate, such as the Lotader® products (SK Functional Polymer), or polyolefins grafted with maleic anhydride, such as the Orevac® products (SK Functional Polymer), and also terpolymers of ethylene, of alkyl acrylate and of (meth)acrylic acid. Mention may also be made of polypropylene homopolymers or copolymers grafted with a carboxylic acid anhydride and then condensed with monoamino polyamides or monoamino polyamide oligomers.

In one embodiment, the polyolefin is crosslinked.

In another embodiment, the polyolefin is a mechanical blend of a thermoplastic olefinic polymer with a polyethylene or polypropylene matrix and of an elastomer, which is vulcanized, such as a vulcanized PP/EPDM blend.

The thermoplastic elastomer is a block copolymer (ether-amide block copolymer: PEBA), ether-ester block copolymer, a thermoplastic polyurethane: TPU, a thermoplastic styrene elastomer).

### As Regards the Filler (d):

The filler represents from 0 to 30%, in particular from 0 to 15%, of a filler.

In one embodiment, the filler represents from 1% to 5%.

By way of example, the fillers may be chosen from silica, graphite, expanded graphite, carbon black, kaolin, magnesia, slag, talc, wollastonite, nanofillers (carbon nanopipes), pigments, metal oxides (titanium oxide) and metals, advantageously wollastonite and talc, preferentially talc or carbon black.

### As Regards the Additives (e)

The additive is optional and comprises from 0 to 10.0%, in particular from 0.1% to 5.0%, by weight.

The additive is chosen from dyes, stabilizers, plasticizers, surfactants, nucleating agents, pigments, brighteners, antioxidants, lubricants, flame retardants, natural waxes, chain extenders, and mixtures thereof.

Advantageously, the additive is chosen from dyes, stabilizers, plasticizers, surfactants, nucleating agents, pigments, brighteners, antioxidants, flame retardants, natural waxes, chain extenders, and mixtures thereof.

More advantageously, the additive is chosen from dyes, stabilizers, plasticizers, surfactants, nucleating agents, pigments, brighteners, antioxidants, natural waxes, chain extenders, and mixtures thereof.

By way of example, the stabilizer may be a UV stabilizer, an organic stabilizer or more generally a combination of organic stabilizers, such as an antioxidant of phenol type (for example of the type such as Irganox® 245 or 1098 or 1010 from the company Ciba-BASF), an antioxidant of phosphite type (for example Irgafos® 126 from the company Ciba-BASF) and even optionally other stabilizers, such as a HALS, which means Hindered-Amine Light Stabilizer (for example Tinuvin® 770 from the company Ciba-BASF), a UV stabilizer (for example Tinuvin® 312 from the company Ciba), or a phosphorus-based stabilizer. Use may also be made of antioxidants of amine type, such as Naugard® 445 from the company Crompton or else polyfunctional stabilizers, such as Nylostab® S-EED from the company Clariant.

This stabilizer may also be a mineral stabilizer, such as a copper-based stabilizer. Examples of such mineral stabilizers that may be mentioned include copper acetates and halides. Incidentally, other metals, such as silver, may possibly be considered, but said metals are known to be less effective.

These copper-based compounds are typically combined with halides of alkali metals, in particular of potassium.

By way of example, the plasticizers are chosen from benzenesulfonamide derivatives, such as n-butylbenzenesulfonamide (BBSA); ethyltoluenesulfonamide or N-cyclohexyltoluenesulfonamide; esters of hydroxybenzoic acids, such as 2-ethylhexyl para-hydroxybenzoate and 2-decylhexyl para-hydroxybenzoate; esters or ethers of tetrahydrofurfuryl alcohol, such as oligoethyleneoxytetrahydrofurfuryl alcohol; and esters of citric acid or of hydroxymalonic acid, such as oligoethyleneoxy malonate.

It would not constitute a departure from the scope of the invention to use a mixture of plasticizers.

In one embodiment, the composition according to the invention contains less than 5% and advantageously less than 2% of plasticizer.

In another embodiment, the composition has an MFI measured according to the standard ISO 1133 at 235° C. under 5 kg of from 0.5 to 25.

According to another aspect, the present invention relates to a process for preparing a recycled semicrystalline aliphatic polyamide as defined above, characterized in that it comprises, after removal and shredding in the form of granules of used or end-of-life pipes from the exploitation platforms of offshore or onshore oil or gas deposits, in particular offshore deposits, a step of washing and/or compounding of said semicrystalline aliphatic polyamide PA2.

According to another aspect, the invention relates to the use of a composition as defined above, for preparing articles obtained by extrusion.

According to yet another aspect, the present invention relates to a process for preparing a monolayer or multilayer pipe, characterized in that it comprises a step of extruding a composition as defined above.

It is understood that all the embodiments described previously apply equally to an “extrusion” composition or to a composition characterized simply by its viscosity, i.e. a composition with an inherent viscosity, as determined in accordance with ISO 307:2007 in m-cresol at 20° C., of greater than or equal to 1.2 dl/g, notably from 1.2 dl/g to 1.7 dl/g, preferably from 1.4 to 1.7 dl/g, more preferably strictly greater than 1.4 dl/g.

### DESCRIPTION OF THE FIGURES

FIG. 1 presents Jean-Noël Jaubert's odor Field®.

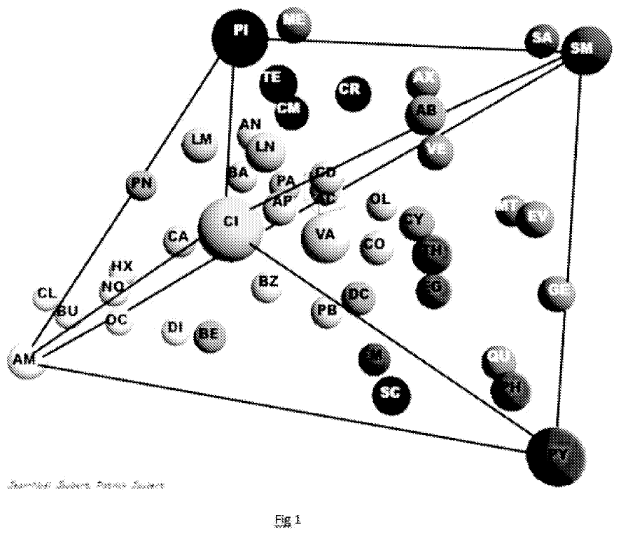

The meaning of the abbreviations used in FIG. 1 is shown in Table 1.

TABLE 1

| | | | |
|---|---|---|---|
| AB = Ambrettolide ® | AC = Cinnamyl alcohol | AM = Isobutylamine | AN = Methyl anthranilate |
| AP = Phenethyl alcohol | AX = Ambroxan ® | BA = Benzaldehyde | BE = Ethyl isobutyrate |
| BU = Butyric acid | BZ = Benzyl acetate | CA = Calone ® | CD = Cinnamaldehyde |
| CI = Citral | CL = Hypochlorite | CM = Camphor | CO = Coumarin |
| CR = β-Caryophyllene | CY = Methyl salicylate | DC = γ-Undecanolactone | DI = Diacetyl |
| EG = Eugenol | EM = Ethylmaltol | EV = Evenyl | GE = Geosmine |
| HX = cis-3-Hexenol | LM = d-Limonene | LN = Linalool | ME = L-Menthol |
| MT = Methional | NO = Nonanal | OC = 1-Octen-3-ol | OL = trans-Anethole |
| PA = Ethylphenyl acetate | PB = p-Hydroxyphenylbutanone | PH = Phenom | PI = α-Pinene |
| PN = Cyclopentanone | PY = 2-Acetylpyrazine | QU = Isobutylquinoline | SA = Diallyl disulfide |
| SC = Skatole | SM = Dimethyl disulfide | TE = Terpinyl acetate | TH = Thymol |
| VA = Vanillin | VE = Vetiveryl acetate | | |

### EXAMPLES

The invention will now be described in greater detail by means of the following examples, which are not limiting.

The various compositions used for the preparation of the pipes of the invention are as follows:
Virgin PA11 1=PA11 of Mn 28 000 g/mol+13% BBSA+1% thermal stabilizer (consisting of 0.7% Lowinox® 44B25 phenol from the company Great Lakes, 0.3% Irgafos® 168 phosphite from the company Ciba).
Virgin PA11 2=Mn PA11 28 2000 g/mol+1% thermal stabilizer (consisting of 0.7% Lowinox® 44B25 phenol from the company Great Lakes, 0.3% Irgafos® 168 phosphite from the company Ciba).
Virgin PA12 1=PA12 of Mn 26 000 g/mol+13% BBSA+1% thermal stabilizer (consisting of 0.7% Lowinox® 44B25 phenol from the company Great Lakes, 0.3% Irgafos® 168 phosphite from the Ciba company).
Recy. PA11 1=composition consisting of 100% virgin PA11 1 as described above, derived from offshore pipes shredded to particle sizes ranging from 0.5 mm to 25 mm The composition comprises 350 ppm of isooctane, 412 ppm of methylcyclohexane, 460 ppm of xylene, 350 ppm of 2-methylnaphthalene and 300 ppm of phenanthrene. The composition also comprises 0.1% bitumen.
Recy. PA11 2=composition consisting of 100% virgin PA11 1 as described above, derived from offshore pipes shredded to particle sizes ranging from 0.5 mm to 25 mm and then washed with methanol for 12 hours at 60° C. The composition comprises 6 ppm of isooctane, 3 ppm of methylcyclohexane, 12 ppm of xylene, 55 ppm of 2-methylnaphthalene and 26 ppm of phenanthrene.
Recy. PA113=composition consisting of 50% virgin PA11 1 as described above, derived from offshore pipes shredded to particle sizes ranging from 0.5 mm to 25 mm and then washed with methanol for 12 hours at 60° C., then compounded under vacuum with 50% virgin PA 11 2 without BBSA. The composition comprises 3 ppm of isooctane, 1 ppm of methylcyclohexane, 5 ppm of xylene, 22 ppm of 2-methylnaphthalene and 15 ppm of phenanthrene.
Recy. PA114=composition consisting of 90% virgin PA11 1 as described above, derived from offshore pipes shredded to particles ranging in size from 0.5 mm to 25 mm and then washed with methanol for 12 hours at 60° C. and compounded with 10% virgin PA11 2, 0.5% of antioxidants (consisting of 0.35% Lowinox® 44B25 phenol from the company Great Lakes, 0.15% Irgafos® 168 phosphite from the company Ciba) and addition of 600 ppm of catalyst (H3PO4). The composition comprises 5 ppm of isooctane, 2 ppm of methylcyclohexane, 11 ppm of xylene, 46 ppm of 2-methylnaphthalene and 22 ppm of phenanthrene.
Recy. PA12 5=composition consisting of 70% virgin PA12 1 derived from offshore pipes shredded to particles ranging in size from 0.5 mm to 25 mm, then washed with methanol for 12 hours at 60° C. and then compounded with 20% virgin PA12 2, 9.5% Orevac® IM800 impact modifier sold by SK FP, 0.5% of antioxidants (consisting of 0.35% Lowinox® 44B25 phenol from the company Great Lakes, 0.15% Irgafos® 168 phosphite from the company Ciba) and the addition of 600 ppm of catalyst (H3PO4). The composition comprises 3 ppm of isooctane, 24 ppm stearic acid, 5 ppm of 4-methylbenzoic acid, 22 ppm of 2-methylnaphthalene and 33 ppm of phenanthrene.

The composition Recy. PA11 3 was prepared by conventional compounding in a Coperion® 40 corotating twin-screw extruder, 70 kg/h, at 300 rpm, at 270° C. with strong degassing of −660 mmHg.

The composition Recy. PA11 4 was prepared by conventional compounding in a Coperion® 40 corotating twin-screw extruder, 70 kg/h, at 300 rpm, 270° C. with direct addition of 600 ppm of H3PO4 catalyst.

The composition Recy. PA12 5 was prepared by conventional compounding in a Coperion® 40 corotating twin-screw extruder, 70 kg/h, at 300 rpm, at 270° C. with direct addition of 600 ppm of H3PO4 catalyst.

The alkanes and aromatic molecules (isooctane, methylcyclohexane, xylene, 2-methylnaphthalene and phenanthrene) are analyzed by thermo-desorption (dynamic headspace at 300° C., for 60 minutes) coupled with gas chromatography (C18 column) fitted with flame ionization detection and a mass spectrometer equipped with an electron impact (EI) source. Quantification is performed in pentadecane equivalent.

For the quantification of the acidic aromatic compounds or monoacids, methanol extraction is required, followed by methylation derivatization on the dry extracts to enhance detection. Analysis is performed by gas chromatography (C18 column) fitted with flame ionization detection and a mass spectrometer equipped with an electron impact source. Quantification is performed in pentadecane equivalent.

### Extruded Plates:

Two types of plates are prepared:
plates A 250 mm wide, 5.5 mm thick and 1 m long
plates B 250 mm wide, 1 mm thick and 1 m long

Before the tests, in order to ensure the best properties for the plates and a good extrusion quality, it is verified that the extruded materials have a residual moisture content before extrusion of less than 0.08%. If this is not the case, an additional step of drying the material is performed before the tests, generally in a vacuum dryer, overnight at 80° C.

To make both types of plate, a Maillefer extruder is used, with a screw diameter of 60 mm and a length of 24D, where D is the screw diameter. No filtration system is used at the end of the screw. The extruder respectively feeds a 280 mm Yvroud die with an 8 mm air gap to make the plates A, and a 280 mm Yvroud die with a 3 mm air gap to make the plates B. The screw speed is adjusted according to the sample geometry, calendering speed and drawing speed. The temperature of the three cooling cylinders ranges between 80° C. and 60° C., depending on product fluidity.

The plates, which meet the characteristics described in the present patent application, were taken, after stabilization of the extrusion parameters, the dimensions of the plates no longer changing over time.

In general, the temperatures of the extruders and of the tools (head, connector and die) should be set so as to be sufficiently higher than the melting temperature of the compositions under consideration, so that they remain in the molten state, thus preventing them from solidifying and blocking the machine.

The plates produced by extrusion above were then evaluated on several criteria:

The results are shown in Table 2.

TABLE 2

| | | | IR thermoforming |
|---|---|---|---|
| | | Exudation after | Heating time |
| | Samples | extrusion | required |
| CE1 | Virgin PA11 1 | Strong (4) (BBSA) | 2′20″ |
| CE2 | Virgin PA11 2 | Weak (1) | 2′20″ |
| CE3 | Virgin PA12 1 | Strong (4) (BBSA) | 2′20″ |
| CE4 | Recy. PA 11 1 | very strong (5) | 1′10″ |
| | | (oil residues) | |
| IE1 | Recy. PA 11 2 | Weak (1) | 1′25″ |
| IE2 | Recy. PA 11 3 | Weak (1) | 1′50″ |
| IE3 | Recy. PA 11 4 | Weak (1) | 1′15″ |
| IE4 | Recy. PA 12 5 | Weak (1) | 1′30″ |

Exudation is determined on 1 mm plates, which are stored for 7 days at 70° C. and 62% RH (relative humidity).

Exudation is manifested by the appearance of a deposit on the surface, and is assessed visually.

The plates are graded from 1 (little exudation) to 5 (considerable exudation) by trained personnel.

Thermoforming is performed on a 5.5 mm thick, 220 mm wide plate obtained after cutting extruded plates on a Kiefel KD 20/25 machine. A “yoghurt pot” type mold with vertical walls 40 mm high and 60 mm in diameter was used. The heating system includes two infrared heating plates (upper and lower) so as to ensure even heating. The heating power is set at 100%. The forming time is 1 sec. A pressure of 4 bar is applied to obtain good thermoforming. The heating times to obtain a sufficient thermoforming temperature are listed in the above table. The compositions of the present invention have the best compromise between exudation and heating time. In particular, the heating time of the compositions of the invention is shorter than that of the comparative compositions CE1, CE2 and CE3, and the exudation of the compositions of the invention is lower than that of the comparative compositions CE1, CE3 and CE4.

1. An extrusion composition comprising, by weight:
a) from 35% to 100% of at least one semicrystalline aliphatic polyamide PA1 comprising at least 30% of recycled semicrystalline aliphatic polyamide PA2 originating from used or end-of-life pipes which have been used in the exploitation of offshore or onshore oil or gas deposits, said recycled semicrystalline aliphatic polyamide PA2 having undergone a washing and/or compounding step after removal and shredding in the form of granules of said pipe;
b) from 0 to 65% of at least one reinforcing fiber;
c) from 0 to 40% of at least one impact modifier;
d) from 0 to 30% of a filler;
e) from 0 to 10% of at least one additive;
the sum of the components a+b+c+d+e is equal to 100%,
the inherent viscosity of said composition, as determined according to ISO 307:2007 in m-cresol at 20° C., being greater than or equal to 1.2 dl/g.

2. The extrusion composition as claimed in claim 1, wherein the recycled semicrystalline aliphatic polyamide PA2 is a long-chain polyamide with an average number of carbon atoms per nitrogen atom of greater than 7.

3. The extrusion composition as claimed in claim 1, wherein said recycled semicrystalline aliphatic polyamide PA2 comprises at least one species chosen from sulfur compounds, alkanes, aliphatic C14 to C18 monoacids, mono- or poly-aromatic compounds and aromatic acids.

4. The extrusion composition as claimed in claim 1, wherein said recycled semicrystalline aliphatic polyamide PA2 comprises at least one species chosen from alkanes, aliphatic C14 to C18 monoacids, mono- or poly-aromatic compounds and aromatic acids.

5. The extrusion composition as claimed in claim 1, wherein said recycled semicrystalline aliphatic polyamide PA2 comprises at least one species chosen from alkanes, mono- or poly-aromatic compounds and aromatic acids.

6. The extrusion composition as claimed in claim 1, wherein said recycled semicrystalline aliphatic polyamide PA2 comprises at least one species chosen from alkanes and mono- or polyaromatic compounds.

7. The extrusion composition as claimed in claim 3, wherein the mass content of said species present in the recycled semicrystalline aliphatic polyamide PA2 ranges from 100 ppm to 2000 ppm.

8. The extrusion composition as claimed in claim 1, which has a characteristic odor comprising sulfur/pyrogen and/or hydrocarbon and/or aromatic, terpene and phenol notes.

9. The extrusion composition as claimed in claim 1, wherein the recycled semicrystalline aliphatic polyamide PA2 has functions resulting from thermolysis reactions in acidic medium, notably amide functions and/or methylene alpha to said amide functions and acid chain ends, chosen from nitrile, ketone and ester functions resulting from reaction of the acid functions of the polyamide with alcohols used during the life of said pipes, in a mole ratio relative to the amide functions higher than that of the same polyamide constituting an unused pipe.

10. The extrusion composition as claimed in claim 9, wherein the mole ratio of functions derived from thermolysis reactions is from 1/10 000 to 1/20, as determined by proton NMR.

11. The extrusion composition as claimed in claim 1, wherein the recycled semicrystalline aliphatic polyamide PA2 has a content of cyclic oligomers chosen from oligomers with a molar mass of less than 1000 g/mol lower than that of the equivalent virgin polyamide.

12. The extrusion composition as claimed in claim 1, wherein the recycled semicrystalline aliphatic polyamide PA2 has a content of alkyl chain ends ranging from 1 ppm to 5000 ppm, said alkyl being C1 to C18 and said content being higher than that of a virgin semicrystalline aliphatic polyamide.

13. A process for preparing a recycled semicrystalline aliphatic polyamide as defined in claim 1, wherein the process comprises, after removal and shredding in the form of granules of used or end-of-life pipes from the exploitation platforms of offshore or onshore oil or gas deposits, a step of washing and/or compounding of said semicrystalline aliphatic polyamide PA2.

14. A process for preparing article obtained by extrusion of a composition as claimed in claim 1.

15. A process for preparing a monolayer or multilayer pipe, wherein the process comprises a step of extruding a composition as claimed in claim 1.
